(19) United States
(12) Patent Application Publication
(10) Pub. No.: US 2025/0204506 A1
(43) Pub. Date: Jun. 26, 2025

(54) ELECTRONIC ICE FISHING TIP-UP WITH ILLUMINATED STRIKE INDICATORS

(71) Applicants: Jason Trout, Pine River, MN (US); Brandon Feldhege, Cold Spring, MN (US)

(72) Inventors: Jason Trout, Pine River, MN (US); Brandon Feldhege, Cold Spring, MN (US)

(21) Appl. No.: 18/395,159

(22) Filed: Dec. 22, 2023

(51) Int. Cl. A01K 97/01

(52) U.S. Cl. CPC A01K 97/01

(57) ABSTRACT

A tip-up apparatus is provided comprising a base extending along a longitudinal axis and a plurality of legs rotatably coupled with the base including a first leg, a second leg and a third leg. A spool assembly is attached to the base, wherein the spool assembly includes a cylindrical portion extending along a spool axis, and an electronic sensor configured for monitoring the rotation of the spool assembly. The tip-up apparatus also includes a light assembly including at least one light indicator configured to illuminate upon rotation of the spool assembly.

### TECHNICAL FIELD

The present disclosure relates to tip-up devices for ice fishing, and more particularly, electronic ice fishing tip-ups with illuminated strike indicators.

### BACKGROUND

Existing tip-ups generally include a base designed to straddle a hole drilled in ice for fishing, a vertical descending member secured to the base, a spool of fishing line secured to the vertical descending member so that the spool can turn freely when a fish strikes the fishing line dangling below. A spring-mounted flag is affixed to one end of the base so that the flag can be bent horizontally and placed under a device that causes the flag to snap into a vertical position when the spool turns, indicating a fish strike.

These traditional tip-ups are prone to a number of problems. The moving mechanical parts exposed to cold air can fail due to freezing. Specifically, the lubricating grease contained within the main spool shaft increases in viscosity as the temperature drops, causing difficulty in rotation of the spool and fish loss. Snow can drift over the top of a traditional tip-up so that the flag is prevented from snapping into a vertical position when a fish strikes. A gust of wind can cause the flag on a traditional tip-up to release, falsely suggesting that a fish has struck the line. The triggering of a traditional tip-up flag indicates only that the spool of fishing line has started to turn; there is no indication of whether, and how rapidly, the line continues to be drawn out by a fish.

Traditional tip-up flags are difficult to see in low-visibility conditions such as dawn, dusk, fog, and blowing snow. Traditional tip-up flags are, of course, impossible to see at night without the aid of a lighting tool such as flashlight. There are a number of tip-up-mounted lighting devices in the prior art that are designed to illuminate in conjunction with a triggered flag. But these lighting devices are still reliant on a mechanical triggering device, most commonly the spring-loaded flag itself.

### SUMMARY

In embodiments of the present disclosure, a tip-up apparatus is provided. The tip-up apparatus includes a base extending along a longitudinal axis and a plurality of legs rotatably coupled with the base including a first leg, a second leg, and a third leg. The tip-up apparatus also includes a spool assembly attached to the base, and the spool assembly includes a cylindrical portion extending along a spool axis. An electronic sensor is configured to monitor the rotation of the spool assembly, and a light assembly includes at least one light indicator configured to illuminate upon rotation of the spool assembly.

In embodiments, each of the plurality of legs has a distal end and a proximal end. Each of the plurality of legs is defined by an arrow shape such that a width of each leg decreases towards the distal end.

In embodiments, the tip-up apparatus includes a magnetic clip configured to receive a line that is arranged on the spool assembly.

In embodiments, the light assembly includes a first light indicator, a second light indicator, and a third light indicator.

In embodiments, the first light indicator illuminates upon rotation of the spool assembly.

In embodiments the second light indicator illuminates once the spool assembly has completed a first predetermined rotational amount corresponding to a length of a line that has been expended from the spool assembly.

In embodiments, the third light indicator illuminates once the spool assembly has completed a second predetermined rotational amount, and the second predetermined rotational amount is different than the first predetermined rotational amount.

In embodiments, the second predetermined rotational amount is greater than the first predetermined rotational amount.

In embodiments, the spool axis defines an axis of rotation of the spool assembly, and the spool axis is approximately perpendicular to the longitudinal axis.

In embodiments, each of the plurality of legs is capable of rotation from a folded position to a deployed position, and when in the folded position, each of the plurality of legs is substantially parallel with the longitudinal axis and when in the deployed position, each of the plurality of legs is angled relative to the longitudinal axis.

In yet another embodiment of the present disclosure, a tip-up apparatus is provided. The tip-up apparatus includes a base extending along a longitudinal axis, a plurality of legs rotatably coupled with the base and configured for actuation between a folded position and a deployed position. The tip-up apparatus also including a spool assembly attached to a second end of the base, and the spool assembly includes a cylindrical portion that is rotatable about a spool axis. An electronic sensor is configured to monitor the rotation of the spool assembly, and a light assembly includes at least one light indicator configured to illuminate upon rotation of the spool assembly. Further, the plurality of legs includes at least three legs, and when the plurality of legs are in the folded position, each of the plurality of legs extend generally parallel with the longitudinal axis, and when the plurality of legs are in the deployed position, each of the plurality of legs extend at an angle relative to the longitudinal axis that has a nonzero value.

In embodiments, the tip-up apparatus includes a magnetic clip configured for receiving a line that is arranged on the spool assembly.

In embodiments, the light assembly includes a first light indicator, a second light indicator, and a third light indicator, and the first light indicator illuminates upon rotation of the spool assembly.

In embodiments, the spool assembly is removably coupled to the base.

In embodiments, the tip-up assembly includes a retention feature configured to retain the spool assembly on the base.

In yet another embodiment of the present disclosure, a tip-up apparatus is provided. The tip-up apparatus includes a base extending along a longitudinal axis, a plurality of legs rotatably coupled with the base and configured for actuation between a folded position and a deployed position. The tip-up apparatus also includes a spool assembly attached to a second end of the base, and the spool assembly has a spool including a cylindrical portion that is rotatable relative to a spool axis. Further, the spool axis extends substantially perpendicular to the longitudinal axis. An electronic sensor is configured to monitor the rotation of the spool assembly, and a light assembly includes at least one light indicator configured to illuminate upon rotation of the spool assembly. Further, a magnetic clip is coupled with the spool assembly and arranged vertically below the spool of the spool assembly and the magnetic clip having an aperture extending therethrough.

In embodiments, the aperture of the magnetic clip is configured for receiving a line arranged on the spool assembly.

In embodiments, each of the plurality of legs has a distal end and a proximal end and wherein each of the plurality of legs is defined by an arrow shape such that a width of each leg decreases towards the distal end.

In embodiments, the light assembly includes a first light indicator, a second light indicator, and a third light indicator, and the first light indicator illuminates upon rotation of the spool assembly.

In embodiments, the second light indicator illuminates once the spool assembly has completed a first predetermined rotational amount corresponding to a length of a line that has been expended from the spool assembly.

### BRIEF DESCRIPTION OF THE DRAWINGS

FIG. 1 is an isometric top view of the tip-up in a deployed position, according to some embodiments.

FIG. 2 is a side view of the entire tip-up in a deployed position, according to some embodiments.

FIG. 3 is a top view of the tip-up of FIG. 2 in the deployed position, according to some embodiments.

FIG. 4 is a side view of the entire tip-up of FIG. 2 in a folded position, according to some embodiments.

FIG. 5 is an additional side view of the entire tip-up of FIG. 4 in the folded position, according to some embodiments.

FIG. 6 is an enlarged side view of a portion of the tip-up of FIG. 2, according to some embodiments.

FIG. 7 is an enlarged side view of a portion of the tip-up of FIG. 2, according to some embodiments.

FIG. 8 is another enlarged side view of the portion of the tip-up of FIG. 7, according to some embodiments.

FIG. 9 is an exploded view of the portion of the tip-up of FIG. 7, according to some embodiments.

FIG. 10 is a perspective view of an alternative tip-up;

FIG. 11A is a front view of the alternative tip-up of FIG. 10;

FIG. 11B is a cross-section view of the alternative tip-up of FIG. 10 taken along line 11B-11B of FIG. 11A;

FIG. 11C is a cross-section view of the alternative tip-up of FIG. 10 taken along line 11C-11C of FIG. 11A;

FIG. 12 is an exploded view of the alternative tip-up of FIG. 10;

FIG. 13 is a perspective view of a connection of a leg to the post of the alternative tip-up of FIG. 10;

FIG. 14 is a top view of the alternative tip-up of FIG. 10 showing the spacing between legs;

FIG. 15 is a side view of a spool assembly of the alternative tip-up of FIG. 10;

FIG. 16 is a rear view of the spool assembly of FIG. 15;

FIG. 17A is a front view of the spool assembly of FIG. 15;

FIG. 17B is a cross-section view of the spool assembly of FIG. 15 taken along line 17B-17B of FIG. 17A;

FIG. 18 is a front view of the alternative tip-up of FIG. 10 shown on a sheet of ice and extending through a ice hole; and

FIG. 19 is a control diagram of a controller of the tip-up of FIG. 1 or alternative tip-up of FIG. 10.

While the disclosure is amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

In the following detailed description, reference is made to the accompanying drawings which form a part hereof, and specific embodiments in which the disclosure may be practiced are shown by way of illustration. It is to be understood that other embodiments may be used and structural changes may be made without departing from the scope of the present disclosure.

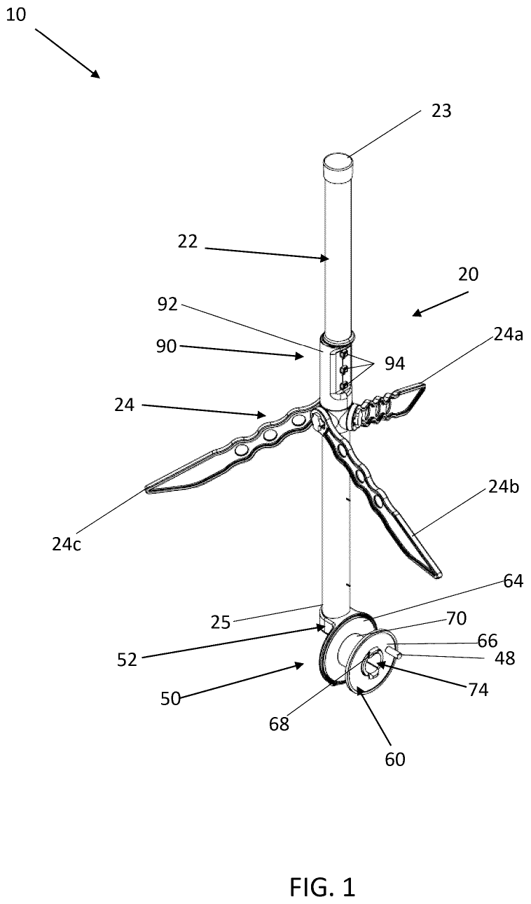

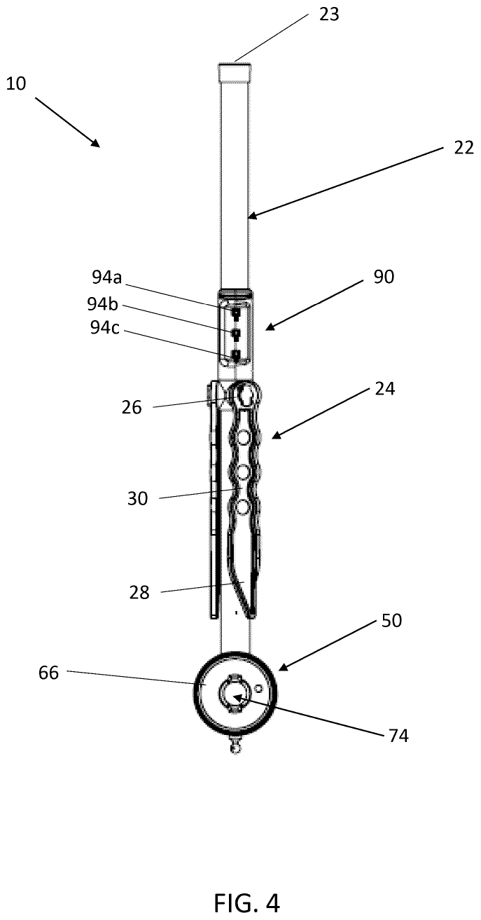

With reference to FIGS. 1-5, a tip-up 10 is illustrated in a deployed configuration. As shown, the tip-up 10 includes a base assembly 20, a spool assembly 50, and a lighting assembly 90 having at least one indicator light 94.

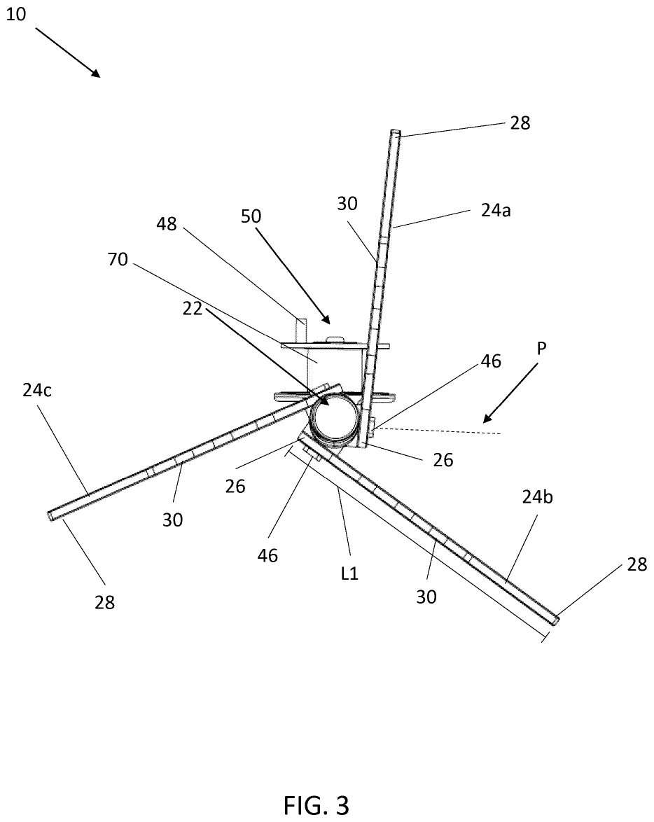

As shown, the base assembly 20 includes a central rod 22 extending along a longitudinal axis L. The central rod 22 has a first end 23 opposite a second end 25. The base assembly 20 further includes a plurality of legs 24 which may be used for providing stability to the tip-up 10 in a deployed position. As illustrated, the plurality of legs 24 includes a first leg 24a, a second leg 24b, and a third leg 24c. However, in additional embodiments, any number of legs 24 may be incorporated into the design. For example, two legs, four legs, five legs or six legs may be incorporated. As best illustrated in the top view of FIG. 3, each of the legs 24 has a length L1. In the illustrative embodiments herein, the value of the length L1 for each of the plurality of legs 24 are equal. However, in other embodiments, the length L1 of each of the legs 24 may vary. In embodiments, the length L1 may have a value ranging between approximately 4 inches and approximately 12 inches. The length L1 may be chosen such that the legs 24 are of sufficient size and strength to straddle a hole of any of a variety of sizes for ice fishing and provide stability to the tip-up 10 in the deployed position against torsional, shear, and normal stresses. For reference, ice augers for cutting holes in ice may be about 4 inches in diameter for manual ice augers, and typically range between 6 and 12 inches in diameter for powered augers.

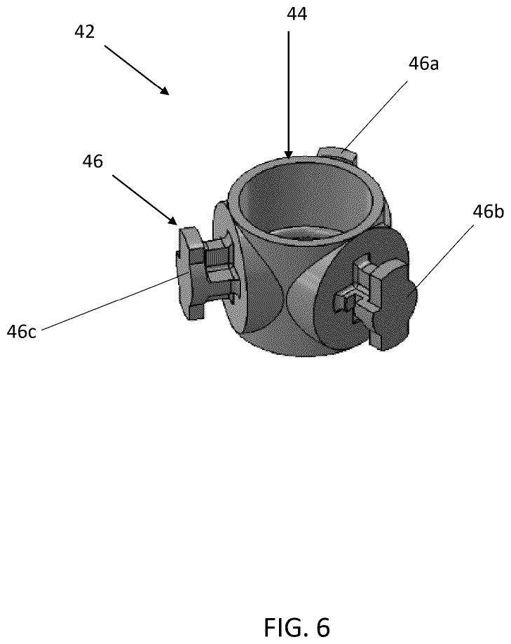

As shown, each of the plurality of legs 24 is coupled to the central rod 22 through the use of a fastening collar 42. More particularly, the fastening collar 42 includes a circular portion 44 that is received over the central rod 22 and includes a plurality of fasteners 46 coupled therewith. For example, as shown in the enlarged view of FIG. 6, the circular portion 44 includes a first fastener 46a, a second fastener 46b, and a third fastener 46c. Each of the plurality of fasteners 46 may correspond to one of the plurality of legs 24 to couple each of the plurality of legs 24 with the central rod 22. The following description regarding the configuration of the first leg 24a along with the affixation to the central rod 22 will be described with reference to only the first leg 24a, however, the description applies to each of the plurality of legs 24.

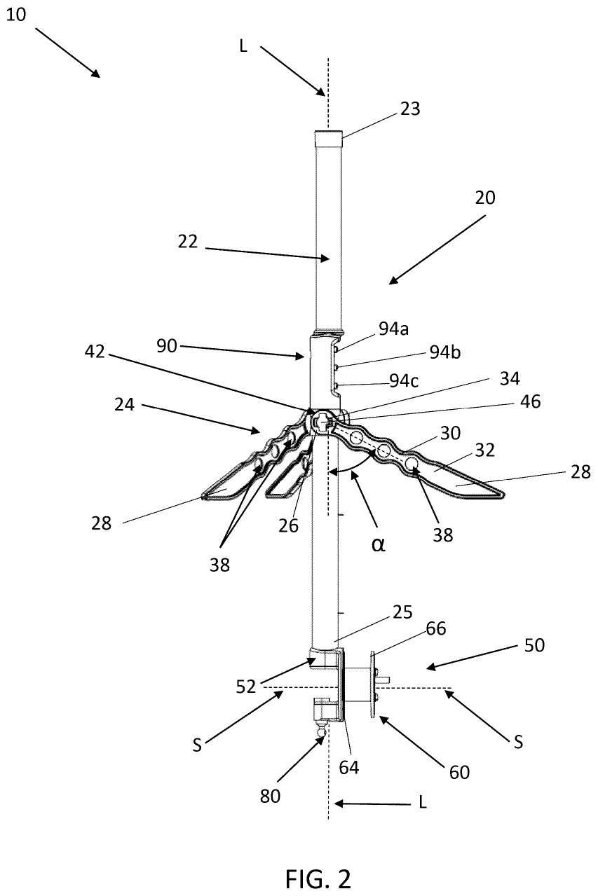

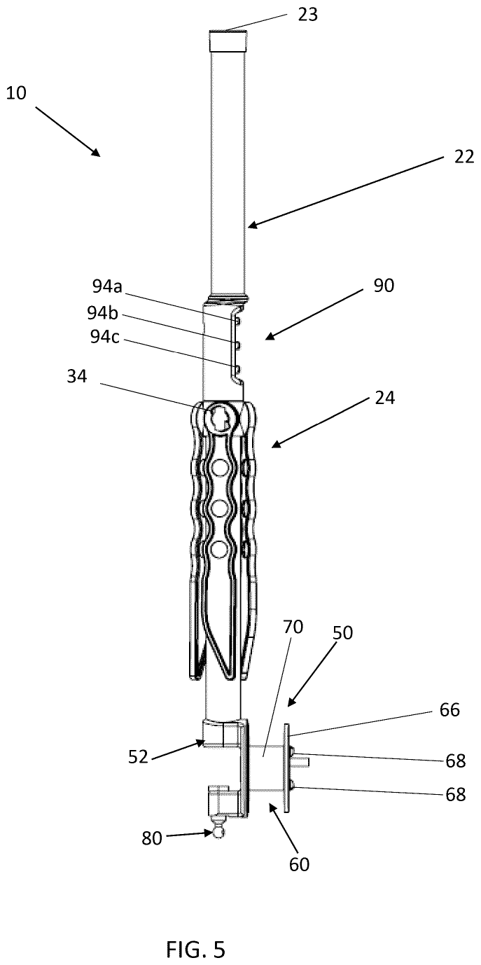

More particularly, as illustrated in FIGS. 1-2, the first leg 24a includes a proximal end 26 and a distal end 28 opposite the proximal end 26 and a body portion 30 extending between the distal end 28 and the proximal end 26. The first leg 24a may include a plurality of openings 38 arranged within the body portion 30 which may reduce the weight of the first leg 24a. The distal end 28 is defined by an arrow or knife configuration such that the distal end 28 has a width that is less than a width of a central portion 32 of the first leg 24a. The first leg 24a is affixed with the fastening collar 42 such that the first leg 24a is rotatably and tangentially coupled relative to the central rod 22. More particularly, the proximal end 26 includes an opening 34 that receives the first fastener 46a for coupling the proximal end 26 with the central rod 22. The first fastener 46a extends along a pivot axis P such that the first leg 24a may engage with the first fastener 46a and rotate from a folded position that is generally parallel with the longitudinal axis (see FIG. 5) to the deployed position show in FIGS. 1-2 with the first leg 24a extending at an angle relative to the longitudinal axis L. In some embodiments, and in the deployed position, the first leg 24a may extend at an angle α which may have a value ranging between approximately 30 to 90 degrees. In further embodiments, the angle α may have a value of approximately 60 degrees.

In the present embodiment, each of first leg 24a, second leg 24b, and third leg 24c are offset by about an angle of 120 degrees about the circumference of central rod 22. The basal area, or envelope, in contact with the ground/ice that is created by legs 24a, 24b, 24c is maximized for three legs to increase stability. In various other embodiments, the offset angle between any number of legs 24 coupled to central rod 22 can be determined by dividing 360 degrees by the number of legs (e.g., for 4 legs, offset angle=360 degrees/4=90 degree offset angle). When legs 24a, 24b, 24c are in the folded position, legs 24a, 24b, 24c remain tangentially coupled to central rod 22, however, they extend flat against central rod 22 and the basal area, or envelope created by legs 24a, 24b, 24c is reduced, making tip-up 10 more compact, storable, and transportable. That is, legs 24a, 24b, 24c are rotatably coupled to central rod 22 through fastening collar 42, and are able to be deployed quickly, allowing tip-up 10 to be transformed between a stored position and usable, deployed position quickly. Similarly, tip-up 10 can be transformed between a usable, deployed position and a stored position quickly.

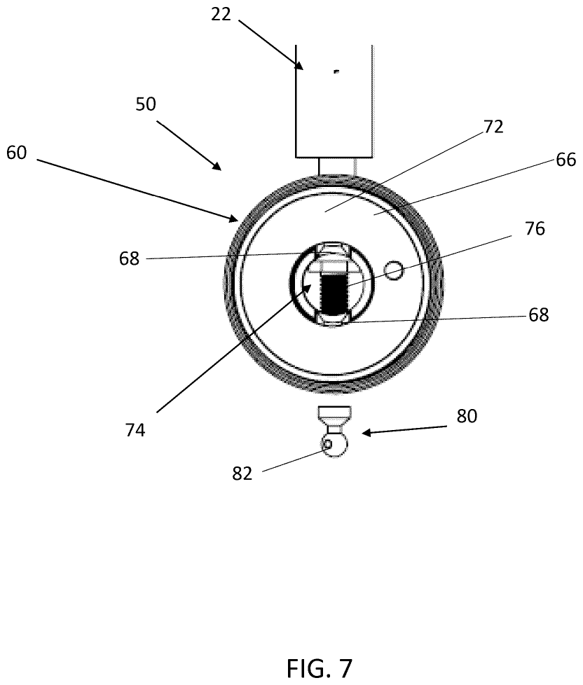

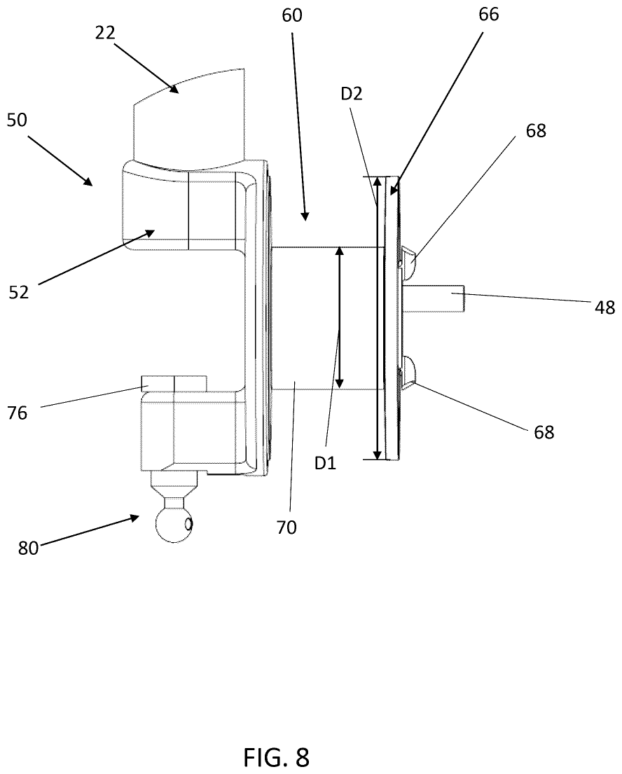

With reference now to FIGS. 1-2 and the enlarged views of FIGS. 7-9, the spool assembly 50 will be described further herein. As shown, the spool assembly includes a spool base 52 that is coupled with the bottom end of the central rod 22. The spool base 52 includes a short spool shaft 54 extending outwardly therefrom. More particularly, the short spool shaft 54 extends along a spool axis S that extends approximately perpendicular to the longitudinal axis L. The short spool shaft 54 is generally cylindrical and extends between a first end 56 and a second end 58. The second end 58 includes at least two tabs 68 extending radially outward from the second end 58.

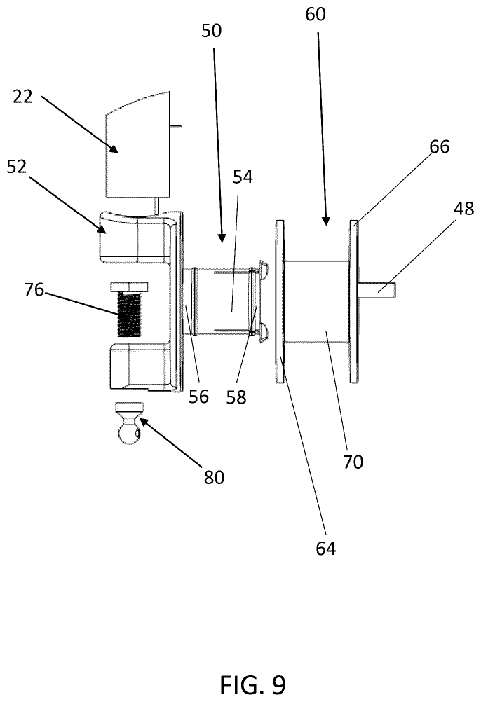

As illustrated best in the exploded view of FIG. 9, the short spool shaft 54 is configured for receiving a spool 60 which is configured for supporting the fishing line. As illustrated, the spool 60 includes a first disc 64 and a second disc 66 and a cylindrical portion 70 extending laterally between the first disc 64 and the second disc 66. The cylindrical portion 70 has a first diameter D1 and the first disc 64 and the second disc 66 are defined by a second diameter D2. As illustrated, the first diameter D1 is less than the second diameter D2. In this way, when fishing line is wrapped around the cylindrical portion 70 of the spool 60, the fishing spool is laterally retained between the first disc 64 and the second disc 66. The second disc 66 additionally includes a spool handle 48 extending outwardly therefrom.

Additionally, as illustrated in FIG. 7, the first disc 64, the second disc 66 and the cylindrical portion 70 each include an opening extending therethrough such that a lumen 74 extends through the spool assembly 50. In this way, the cylindrical portion 70 may be disposed about the short spool shaft 54 in order to secure the spool 60 with the spool assembly 50. For example, as illustrated in FIGS. 7-9, the spool base 52 includes a plurality of tabs 68 which may be used for securing the spool 60 with spool base 52 by engaging an outer side of the second disc 66. In other words, the spool 60 may be pushed onto the spool base 52 until the tabs 68 are engaged with an outer surface 72 of the second disc 66 which indicates to the operator that the spool 60 is in the desired position. In some embodiments, the plurality of tabs 68 may be actuated inwards to increase the ease with which the operator can slide the spool 60 onto the spool base 52 or remove the spool 60 from the spool base 52 when the spool 60 needs to be changed.

The spool assembly 50 further includes a magnetic clip 80 which may be secured to the spool base 52 through the use of a fastener 76, illustratively a screw, that is received through the spool base 52 and into engagement with the magnetic clip 80. Once coupled, the magnetic clip 80 is arranged vertically below the spool base 52 and the spool 60. Additionally, as illustrated, the magnetic clip 80 includes an aperture 82 extending therethrough which may receive the fishing line, as will be described further herein. Further, while described herein as having one magnetic clip 80, more than one magnetic clip may be incorporated. For example, the tip-up 10 may include two, three, four or up to ten magnetic clips for use with the tip-up 10.

With reference again to FIGS. 1-3, the tip-up 10 further includes a lighting assembly 90 electrically and mechanically coupled with the central rod 22. More particularly, a light base 92 is mechanically coupled with the central rod 22 and includes at least one light indicator 94. Illustratively, the lighting assembly 90 includes a first light indicator 94a, a second light indicator 94b and a third light indicator 94c. Although not shown, in some embodiments, the tip-up 10 may include a printed circuit board arranged within the central rod 22 and electronically coupled with the lighting assembly 90 and an electronic sensor. In embodiments, electronic sensors may include vision sensors, potentiometers, lighting sensors, force sensors, acceleration sensors, rotational sensors, or other sensors. In various embodiments, tip-up 10 includes a battery (not shown) or a plurality of batteries configured to provide power to the circuit board, the lighting assembly, an associated speaker, and other powered components associated with tip-up 10.

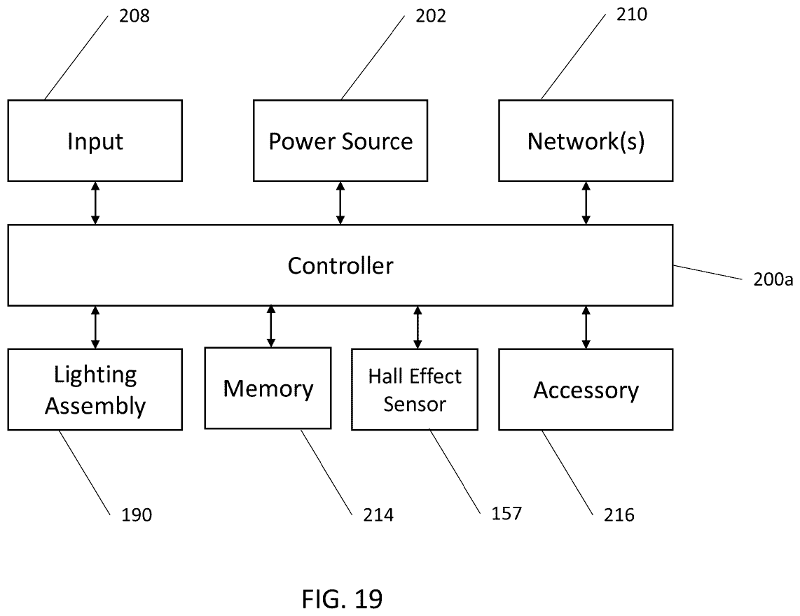

The lighting assembly 90 and each of the plurality of light indicators 94 may be configured for signaling to a user the status of the fishing line (i.e., the amount of fishing line expended from spool 60) and if the operator has received a bite on the fishing line or if a fish has taken the line and is swimming away from tip-up 10. For example, in some embodiments, the electronic sensor may monitor rotation of the spool assembly 50 in order to determine the amount, or length of fishing line that extends below the spool assembly 50 or the magnetic clip 80. The sensor may communicate with the lighting assembly 90 (i.e., via a controller (e.g., controller 200a, FIG. 19) on the circuit board) such that if the tip-up 10 has expended approximately 5 feet of fishing line past either the spool 60 or magnetic clip 80, the first light indicator 94a may be actuated (i.e., illuminated and emitting a light). In some embodiments, the light emitted may be a blue light, however in other examples, the light may emit a different color (e.g., red or green). In further embodiments, if the fishing line extends approximately 15 feet below the coupling point through the magnetic clip 80, the first light indicator 94a and the second light indicator 94b may emit a blue light to the operator. If the fishing line extends approximately 25 feet or more below the coupling point with the magnetic clip 80, each of the first light indicator 94a, second light indicator 94b, and third light indicator 94c may emit the light to the user. In various embodiments, the amount of fishing line expended is determined based upon the number of rotations experienced by the spool 60. In various embodiments, at various lengths of fishing line expended, light indicators 94a, 94b, 94c may emit different colors so that a user may identify a length of fishing line expended from a distance. However, the above noted distances and signals are provided merely as examples. Various other signals may be incorporated into the tip-up 10. For example, the central rod 22 may include a speaker that emits a sound indicating the status of the fishing line during operation. These signals provide an automated and more detailed indication to the operator of when a fish bites the fishing line so that the operator may act quickly.

In this way, during operation, fishing line may be wrapped around the cylindrical portion 70 of the spool 60. A free end of the line may extend vertically downward and be received within the opening 82 of the magnetic clip 80 such that the magnetic clip 80 rides along the fishing line. The spool assembly 50 and the magnetic clip 80 may be arranged within water filling an ice fishing hole and the free end of the fishing line is free for receiving a fish bite within the water. Once a fish grabs onto the fishing line and there is tension on the fishing line, due to the arrangement of the cylindrical portion 70 onto the spool base 52 and the tension on the fishing line, the spool 60 may freely rotate and increase the length of fishing line that is pulled in the water. The spool 60 may also be manually rotated through actuation of the spool handle.

Due to the arrangement of the line extending through the magnetic clip 80, the fishing line remains substantially free of tangles during operation. The amount of fishing line that is pulled off the spool may be monitored through the rotation of the spool 60 and a signal may be provided to a controller (e.g., controller 200a, FIG. 19) of the circuit board to cause at least one of the light indicators 94 to be actuated in accordance with the above description. Thus, the above described embodiment of the tip-up 10 provides for an electronic tip-up assembly that provides the operator with clear signaling of the status of the fishing line while the spool assembly 50 sits within the water of an ice fishing hole. The tip-up 10 additionally provides for an efficient spool change out process along with a magnetic clip for holding the line during operation of the tip-up 10 to avoid tangling the fishing line.

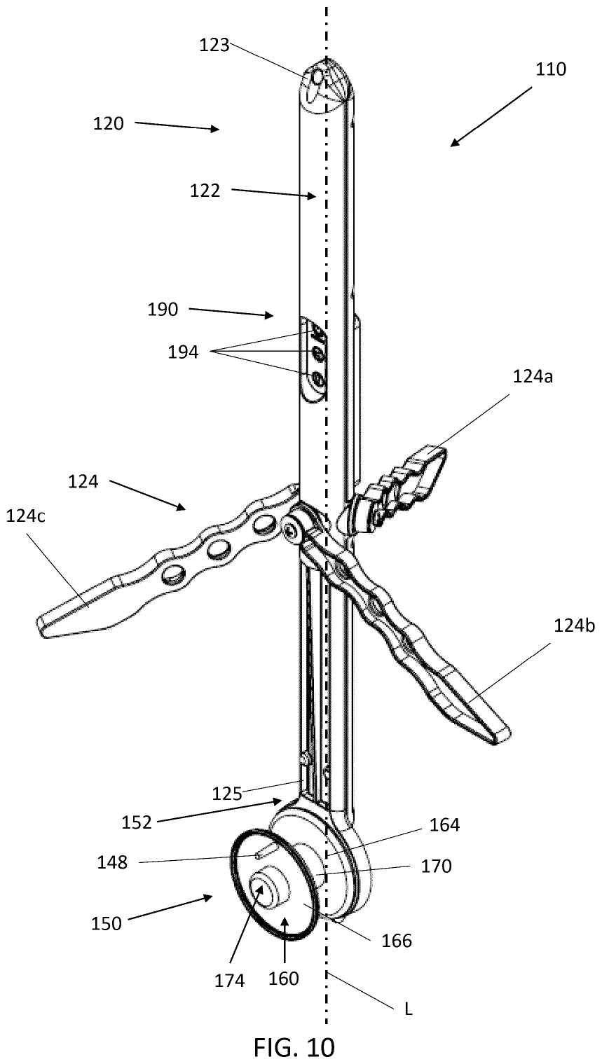

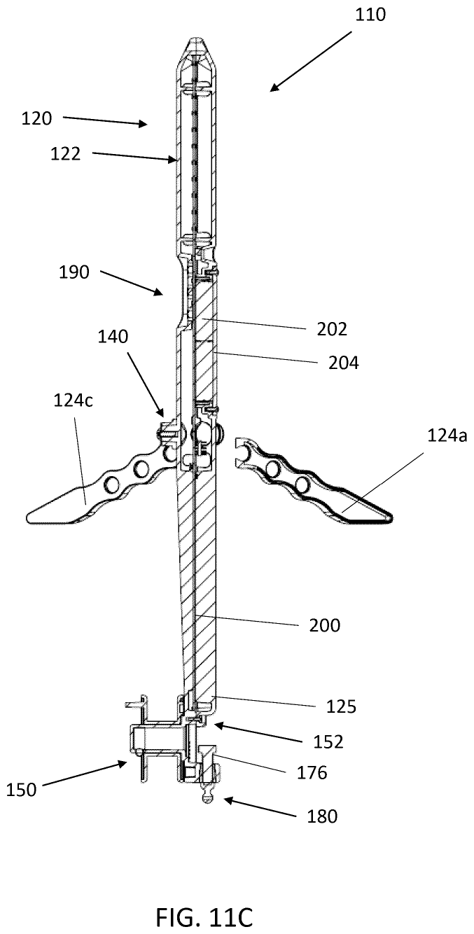

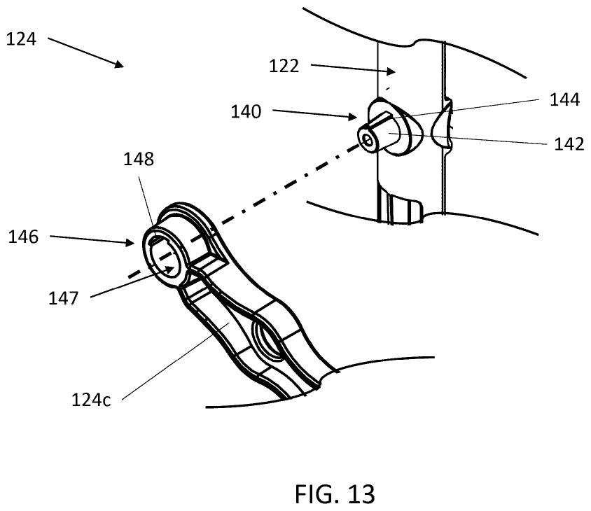

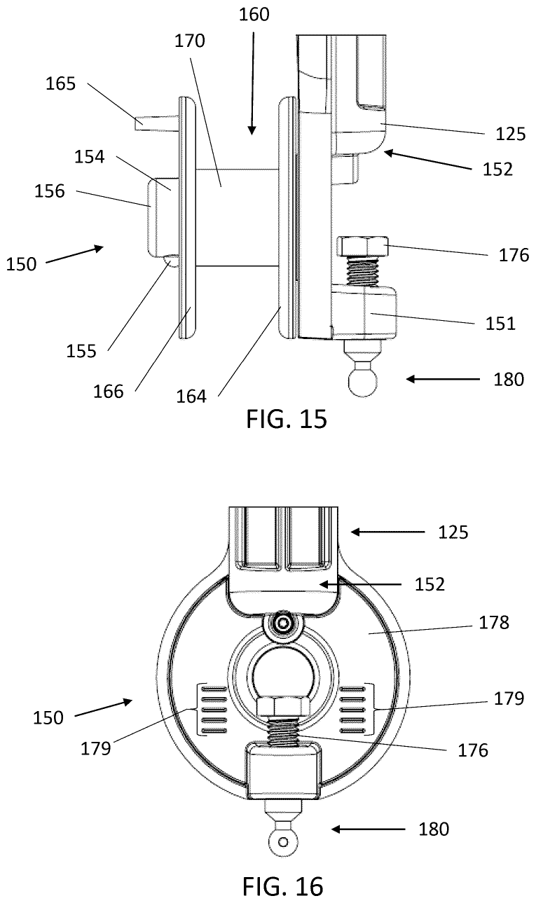

Referring now to FIGS. 10-17B, an alternative electronic tip-up assembly 110 includes a main body portion 120 including a shaft 122 extending along a longitudinal axis L. In various embodiments, shaft 122 includes a first shaft portion 122a and a second shaft portion 122b (FIG. 12). First shaft portion 122a and second shaft portion 122b are coupled by a plurality of fasteners 121. In embodiments, first shaft portion 122a and second shaft portion 122b may be coupled by one or more clasps, magnets, nuts, hook-and-loop, or other fastening systems. In embodiments, first shaft portion 122a and second shaft portion 122b are transparent and may be generally see-through. In embodiments, first shaft portion 122a and second shaft portion 122b are generally frosted.

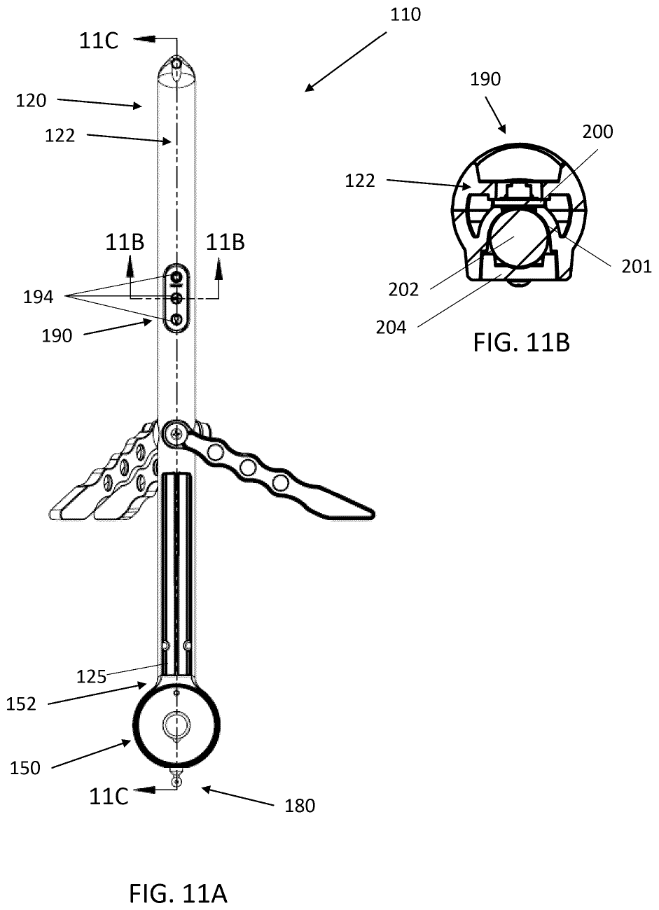

Referring now to FIGS. 10-11C, main body portion 120 of alternative electronic tip-up assembly 110 includes a first end 123 and a second end 125 opposite the first end 123. First end 123 is generally positioned at an upper extent of main body portion 120 and second end 125 is generally at a lower extent of main body portion 120. A plurality of legs 124 are coupled to main body portion 120 including a first leg 124a, a second leg 124b, and a third leg 124c.

Alternative electronic tip-up assembly 110 includes a circuit board 200 positioned intermediate the first shaft portion 122a and second shaft portion 122b. Circuit board 200 generally extends along a vertical plane. Second shaft portion 122b generally defines a recessed portion 201 configured to receive one or more power sources 202. In embodiments, power sources 202 are batteries 202. In embodiments, power source 202 may also be a solar panel, a turbine, or another power source. A cover 204 is configured to cover and confine batteries 202 within recessed portion 201. In embodiments, power source 202 may be one or more rechargeable batteries, and alternative electronic tip-up assembly 110 may include a charging port electronically coupled to the rechargeable batteries to reduce the need for replacing batteries.

Referring to FIG. 19, in embodiments, circuit board 200 includes a controller 200a which may be operably coupled to power source 202. Controller 200a may also be coupled to an input 208 (e.g., buttons, switches, knobs, dials, a display, or another type of input). Controller 200a may also be coupled to a network 210 such as a cellular network, a wireless network, a GPS network, or may also be coupled to a Bluetooth network. Controller 200a may also be coupled to a memory 214 (e.g., ROM) or an accessory 216. In embodiments, controller 200a may also be coupled to a lighting assembly 190. In embodiments, controller 200a may also be coupled to one or more speakers (not shown) configured to emit a noise, sound, or alert.

Referring to FIG. 11A, lighting assembly 190 includes a plurality of LEDs (Light Emitting Diodes) 194 coupled to circuit board 200 and configured to display lights through a lighting panel 195 (FIG. 12). In embodiments, LEDs 194 includes three lights, including a first light 194a, a second light 194b, and a third light 194c. Lighting assembly 190 may also include a plurality of LEDs 193 (FIG. 12) coupled to circuit board 200 and positioned vertically above LEDs 194. As shown in FIG. 12, LEDs 193 extend upwardly from LEDs 194 and are positioned intermediate first shaft portion 122a and second shaft portion 122b. Further, first shaft portion 122a and second shaft portion 122b are transparent and LEDs 193 may be viewed through shaft 122. In embodiments, LEDs 193 are positioned on one or both sides of circuit board 200. That is, alternative electronic tip-up assembly 110 may be viewable from a distance when LEDs 193 are illuminated through transparent shaft 122. In embodiments, LEDs 193 are configured to illuminate different colors based on different conditions. In various embodiments, LEDs 193 are configured to illuminate a first color (e.g., red) when alternative electronic tip-up assembly 110 has expelled fishing line and is ready to catch a fish. In various embodiments, LEDs 193 are configured to illuminate a second color (e.g., blue) when controller 200a of alternative electronic tip-up assembly 110 determines that a fish has been caught on the fishing line. That is, a user/operator of alternative electronic tip-up assembly 110 can determine the status of alternative electronic tip-up assembly 110 from a distance and the user/operator does not need to remain next to alternative electronic tip-up assembly 110 to determine when a fish is caught. In embodiments, LEDs 193, 194 may be other types of lights.

Alternative electronic tip-up assembly 110 also includes a spool assembly 150 coupled to main body portion 120 adjacent second end 125. Spool assembly 150 generally includes a spool base 152 and a spool extension 154 configured to support a spool 160. In embodiments, spool base 152 is integral with second end 125. In embodiments, spool base 152 is integral with first shaft portion 122a (FIG. 12).

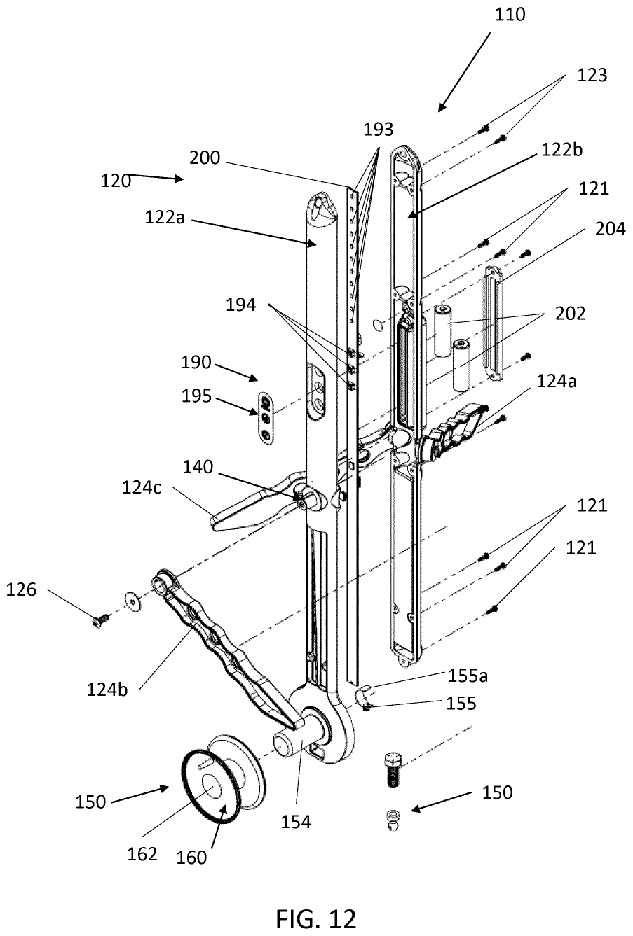

Referring now to FIGS. 12-13, alternative electronic tip-up assembly 110 also includes a plurality of leg assemblies 124. In embodiments, alternative electronic tip-up assembly 110 includes three leg assemblies 124. Each leg assembly 124 includes a post 140 comprising a cylindrical post base 142 and a spline 144 extending radially outwardly from the cylindrical post base 142. Each leg assembly 124 also includes a leg 124a, 124b, 124c, configured to couple with each post 140. Each leg 124a, 124b, 124c includes a first end 146 defining an aperture 147 and a notch 148. In embodiments, the aperture 147 is configured to receive the post base 142 and the notch 148 is configured to receive the spline 144. Notch 148 generally defines a range of motion that leg 124a, 124b, 124c may rotate about post 140. That is, spline 144 generally rests within notch 148 and leg 124a, 124b, 124c may rotate relative to post 140 within the range of motion defined by notch 148. In embodiments, leg assemblies 124 include a fastener 126 configured to couple legs 124a, 124b, 124c to the post 140.

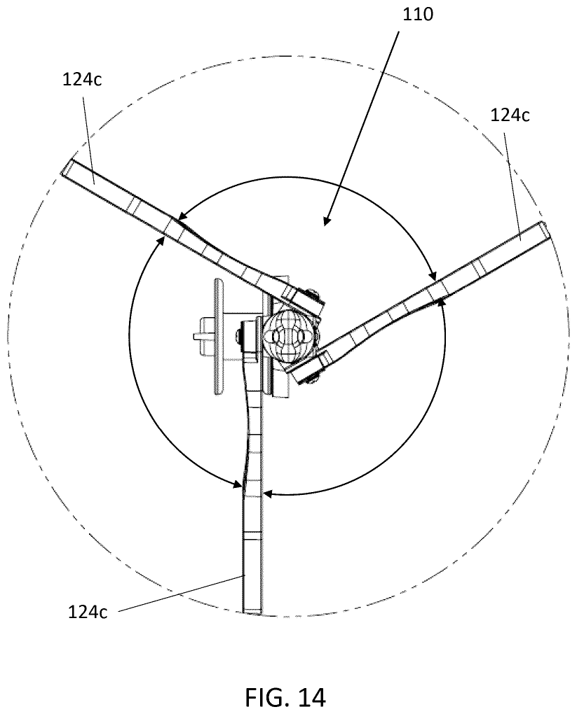

Referring now to FIGS. 15-17B, spool base 152 includes an extension 151 extending outwardly from a bottom portion of spool base 152. Extension 151 defines an aperture 177 configured to receive a fastener 176. Illustratively, fastener 176 is a threaded screw and aperture 177 is a threaded aperture configured to receive the fastener 176. A magnetic clip 180 is configured to magnetically couple to fastener 176 to couple magnetic clip 180 to spool base 152. Magnetic clip 180 defines an aperture 181 extending therethrough.

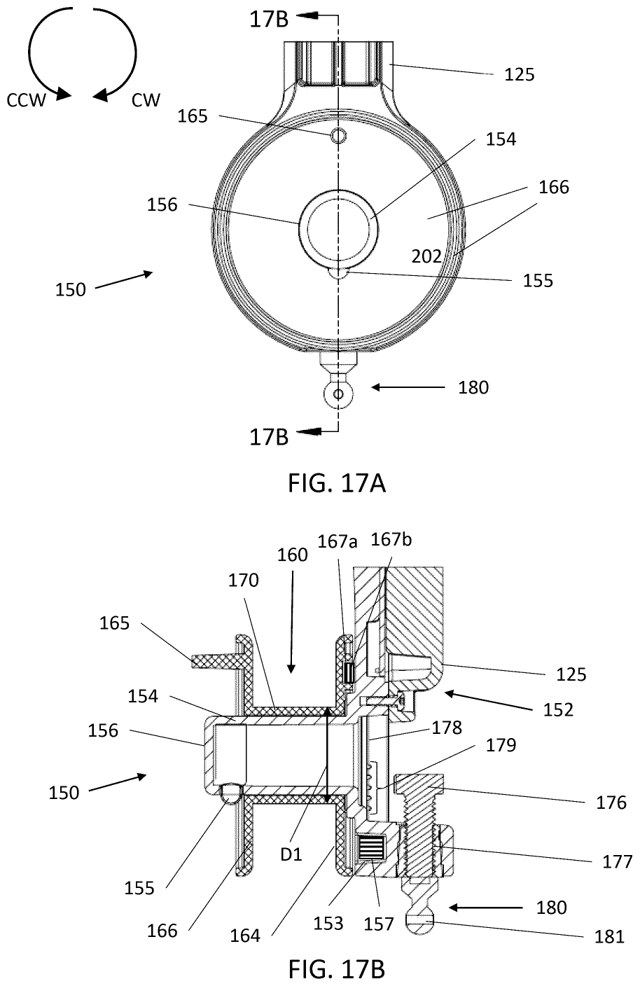

Still referring now to FIGS. 15-17B, spool 160 includes an inner spool section 170, or cylindrical portion 170, a first outer ring 164 and a second outer ring 166. In embodiments, a wire (e.g., fishing wire) is configured to be wound around spool 160 and sit between outer rings 164, 166. Spool 160 also defines an aperture 162, and spool 160 is configured to sit on extension 154 by extension 154 extending through aperture 162. Extension 154 includes a button 155 which may be depressable, or compressable, between a compressed and decompressed position. In the compressed position, the button 155 is generally flush with extension 154, and in the decompressed position (e.g., FIG. 17B), button 155 extends outwardly from extension 154, or stands proud of extension 154. In embodiments, button 155 defaults to the decompressed position. In embodiments, button 155 is generally elastic so that it may naturally return to the decompressed position after being compressed. In embodiments, button 155 is coupled to a spring member 155a (FIG. 12) configured to allow for button 155 to be compressed relative to extension 154 and further allow button 155 to recoil back to the decompressed position. Further, spool 160 may slide onto extension 154, past button 155, and button 155 may default to the decompressed position to retain spool 160 on extension 154. That is, button 155 is a retention mechanism to retain spool 160 on extension 154. Further, button 155 may be depressed to allow spool 160 to be removed from extension 154. A user/operator may utilize a plurality of spools 160 which include different fishing lines, lures, leaders, or other components and may quickly switch which spool 160 is positioned on the tip-up 10, 110. In embodiments, spool 160 also includes a spool handle 165 which may be used to rotate spool 160 about extension 154.

Still referring to FIGS. 15-17B, spool 160 may define an aperture 167a that is positioned on first outer ring 164 and facing generally outwardly toward spool base 152. Further, a magnet 167b may be positioned within aperture 167a and may rotate with spool 160 about extension 154. Spool base 152 generally defines an aperture 153 configured to receive a sensor 157, such as a hall effect sensor 157, configured to measure a magnetic field (e.g., from magnet 167b). In embodiments, hall effect sensor 157 is operably coupled to controller 200a. Further, hall effect sensor 157 is configured to receive a signal each time that magnet 167b passes sensor 157 and controller 200a may be configured to count the number of rotations of spool 160 based upon the number of times magnet 167b passes sensor 157. In embodiments, controller 200a is configured to determine the number of times spool 160 spins clockwise (CW) and the number of times spool 160 spins counter-clockwise (CCW). Controller 200a may then be configured to determine, based upon the number of turns experienced by spool 160, how much fishing line has been expelled from spool 160. In embodiments, alternative electronic tip-up assembly 110 includes another type of sensor, and sensor 157 is a vision sensor, audio sensor, voltage sensor, current sensor, potentiometer, force sensor, acceleration sensor, rotational sensor, or other sensor configured to determine a movement characteristic of the spool 160. In embodiments, the sensor 157 is configured to determine the number of rotations of spool 160, a rotational speed of spool 160, a rotational acceleration of spool 160, a rotational direction of spool 160, or another movement characteristic of the spool 160.

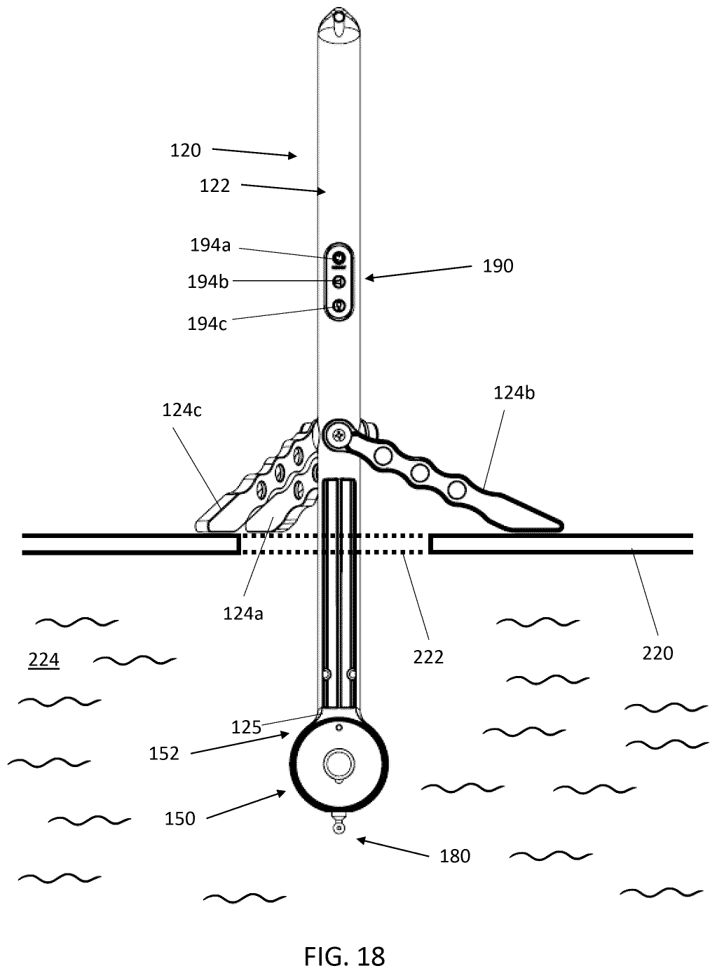

Referring now to FIG. 17B, fastener 176 is rotatable within aperture 177 to change the height of fastener 176 relative to aperture 177 and magnetic clip 180. Similar to electronic tip-up 10, as fastener 176 is translated up-and-down within aperture 177, magnetic clip 180 moves closer or farther away from extension 151. Magnetic clip 180 may be configured to retain fishing line through aperture 181 to help prevent tangling or knots from developing in the fishing line. That is, fishing line may be wrapped around cylindrical portion 170 of spool 160 and may then extend downwardly, through aperture 181 of magnetic clip 180, and down through an ice fishing hole 222 (FIG. 18). Referring still to FIGS. 15-17B, fastener 176 is moveable up-and-down to change the height of magnetic clip 180, aperture 181, and fishing line extending therethrough. Spool base 152 defines an outer face 178 generally facing away from spool 160 and facing toward fastener 176. Outer face 178 defines a plurality of reference lines 179 configured to provide references for a height of fastener 176. That is, reference lines 179 include a plurality of vertically spaced, horizontal lines, and a user/operator may move fastener up-and-down along the reference lines 179 so that a user/operator may set a preferred height of magnetic clip, aperture 181, and the fishing line extending therethrough.

Referring now to FIG. 18, an ice sheet 220 defines the ice hole 222, and a portion of alternative electronic tip-up assembly 110 is configured to extend downwardly through ice hole 222. That is, legs 124a, 124b, 124c are supported by ice sheet 220 and second end 125 of shaft 122 extends downwardly through ice hole 222 and spool assembly 150 is configured to sit either within ice hole 222 or in a body of water 224 underneath the ice sheet 220.

In embodiments, alternative electronic tip-up assembly 110 operates substantially similar to tip-up 10. That is, the lighting assembly 190 and each of the plurality of LEDs 194, or lighting indicators 194, may be configured for signaling to a user the status of the fishing line (i.e., the amount of fishing line expended from spool 160) and if the operator has received a bite on the fishing line or if a fish has taken the line and is swimming away from tip-up 10, 110. For example, in some embodiments, the hall-effect sensor 157 may monitor rotation of the spool assembly 150 in order to determine the amount, or length of fishing line that extends below the spool assembly 150 or the magnetic clip 180. The hall effect sensor 157 may communicate with the lighting assembly 90 (i.e., via controller 200a on the circuit board) such that if the tip-up 10, 110 has expended approximately 5 feet of fishing line past either the spool 160 or magnetic clip 180, the first light indicator 194a (FIG. 18) may be actuated (i.e., illuminated and emitting a light). In some embodiments, the light emitted may be a blue light, however in other examples, the light may emit a different color (e.g., red or green). In further embodiments, if the fishing line extends approximately 15 feet below the coupling point through the magnetic clip 180, the first light indicator 194a and the second light indicator 194b may emit a blue light to the operator. If the fishing line extends approximately 25 feet or more below the coupling point with the magnetic clip 180, each of the first light indicator 194a, second light indicator 194b, and third light indicator 194c may emit the light to the user. In various embodiments, the amount of fishing line expended is determined based upon the number of rotations experienced by the spool 160. In various embodiments, at various lengths of fishing line expended, light indicators 194a, 194b, 194c may emit different colors so that a user may identify a length of fishing line expended from a distance. However, the above noted distances and signals are provided merely as examples. Various other signals may be incorporated into the tip-up 10, 110. For example, the rod 122 may include a speaker that emits a sound indicating the status of the fishing line during operation. These signals provide an automated and more detailed indication to the operator of when a fish bites the fishing line so that the operator may act quickly.

In this way, during operation, fishing line may be wrapped around the cylindrical portion 170 of the spool 160. A free end of the line may extend vertically downward and be received within the aperture 181 of the magnetic clip 180 such that the magnetic clip 180 rides along the fishing line. The spool assembly 150 and the magnetic clip 180 may be arranged within water filling an ice fishing hole and the free end of the fishing line is free for receiving a fish bite within the water. Once a fish grabs onto the fishing line and there is tension on the fishing line, due to the arrangement of the cylindrical portion 170 onto the spool base 152 and the tension on the fishing line, the spool 160 may freely rotate and increase the length of fishing line that is pulled in the water. The spool 160 may also be manually rotated through actuation of the spool handle 165.

Due to the arrangement of the line extending through the magnetic clip 180, the fishing line remains substantially free of tangles during operation. The amount of fishing line that is pulled off the spool may be monitored through the rotation of the spool 160 and a signal may be provided to a controller (e.g., controller 200a, FIG. 19) of the circuit board to cause at least one of the light indicators 194a, 194b, 194c to be illuminated in accordance with the above description. Thus, the above described embodiment of the tip-up 10, 110 provides for an electronic tip-up assembly that provides the operator with clear signaling of the status of the fishing line while the spool assembly 150 sits within the water of an ice fishing hole. The tip-up 10, 110 additionally provides for an efficient spool change out process along with a magnetic clip for holding the line during operation of the tip-up 10, 110 to avoid tangling the fishing line.

Various modifications and additions can be made to the exemplary embodiments discussed without departing from the scope of the present disclosure. For example, while the embodiments described herein refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

1. A tip-up apparatus, comprising:
a base extending along a longitudinal axis;
a plurality of legs rotatably coupled with the base including a first leg, a second leg and a third leg;
a spool assembly attached to the base, wherein the spool assembly includes a cylindrical portion extending along a spool axis;
an electronic sensor configured for monitoring the rotation of the spool assembly; and
a light assembly including at least one light indicator configured to illuminate upon rotation of the spool assembly.

2. The tip-up apparatus of claim 1, wherein each of the plurality of legs has a distal end and a proximal end and wherein each of the plurality of legs is defined by an arrow shape such that a width of each leg decreases towards the distal end.

3. The tip-up apparatus of claim 1, further comprising a magnetic clip configured for receiving a line that is arranged on the spool assembly.

4. The tip-up apparatus of claim 1, wherein the light assembly includes a first light indicator, a second light indicator and a third light indicator.

5. The tip-up apparatus of claim 4, wherein the first light indicator illuminates upon rotation of the spool assembly.

6. The tip-up apparatus of claim 4, wherein the second light indicator illuminates once the spool assembly has completed a first predetermined rotational amount corresponding to a length of a line that has been expended from the spool assembly.

7. The tip-up apparatus of claim 6, wherein the third light indicator illuminates once the spool assembly has completed a second predetermined rotational amount, the second predetermined rotational amount being different than the first predetermined rotational amount.

8. The tip-up apparatus of claim 7, wherein the second predetermined rotational amount is greater than the first predetermined rotational amount.

9. The tip-up apparatus of claim 1, wherein the spool axis defines an axis of rotation of the spool assembly, and wherein the spool axis is approximately perpendicular to the longitudinal axis.

10. The tip-up apparatus of claim 1, wherein each of the plurality of legs is capable of rotation from a folded position to a deployed position, wherein when in the folded position, each of the plurality of legs is substantially parallel with the longitudinal axis and when in the deployed position, each of the plurality of legs is angled relative to the longitudinal axis.

11. A tip-up apparatus, comprising:
a base extending along a longitudinal axis;
a plurality of legs rotatably coupled with the base and configured for actuation between a folded position and a deployed position;
a spool assembly attached to a second end of the base, wherein the spool assembly includes a cylindrical portion that is rotatable about a spool axis;
an electronic sensor configured for monitoring the rotation of the spool assembly;
a light assembly including at least one light indicator configured to illuminate upon rotation of the spool assembly; and
wherein the plurality of legs includes at least three legs, and when the plurality of legs are in the folded position, each of the plurality of legs extend generally parallel with the longitudinal axis, and when the plurality of legs are in the deployed position, each of the plurality of legs extend at an angle relative to the longitudinal axis that has a nonzero value.

12. The tip-up apparatus of claim 11, further comprising a magnetic clip configured for receiving a line that is arranged on the spool assembly.

13. The tip-up apparatus of claim 11, wherein the light assembly includes a first light indicator, a second light indicator and a third light indicator, and wherein the first light indicator illuminates upon rotation of the spool assembly.

14. The tip-up apparatus of claim 11, wherein the spool assembly is removably coupled to the base.

15. The tip-up apparatus of claim 14, further comprising a retention feature configured to retain the spool assembly on the base.

16. A tip-up apparatus, comprising:
a base extending along a longitudinal axis;
a plurality of legs rotatably coupled with the base and configured for actuation between a folded position and a deployed position;
a spool assembly attached to a second end of the base, the spool assembly having a spool including a cylindrical portion that is rotatable relative to a spool axis, the spool axis extending substantially perpendicular to the longitudinal axis;
an electronic sensor configured for monitoring the rotation of the spool assembly;
a light assembly including at least one light indicator configured to illuminate upon rotation of the spool assembly; and
a magnetic clip coupled with the spool assembly and arranged vertically below the spool of the spool assembly and the magnetic clip having an aperture extending therethrough.

17. The tip-up apparatus of claim 16, wherein the aperture of the magnetic clip is configured for receiving a line arranged on the spool assembly.

18. The tip-up apparatus of claim 16, wherein each of the plurality of legs has a distal end and a proximal end and wherein each of the plurality of legs is defined by an arrow shape such that a width of each leg decreases towards the distal end.

19. The tip-up apparatus of claim 16, wherein the light assembly includes a first light indicator, a second light indicator and a third light indicator, and wherein the first light indicator illuminates upon rotation of the spool assembly

20. The tip-up apparatus of claim 19, wherein the second light indicator illuminates once the spool assembly has completed a first predetermined rotational amount corresponding to a length of a line that has been expended from the spool assembly.
